(19) United States
(12) Patent Application Publication
(10) Pub. No.: US 2015/0262471 A1
(43) Pub. Date: Sep. 17, 2015

(54) UNIVERSAL REMINDER AND WARNING DEVICE

(71) Applicants: Wayne Martin, Fisherville, KY (US); David Bunthean Chin, Louisville, KY (US)

(72) Inventors: Wayne Martin, Fisherville, KY (US); David Bunthean Chin, Louisville, KY (US)

(21) Appl. No.: 14/623,531

(22) Filed: Feb. 17, 2015

Related U.S. Application Data
(60) Provisional application No. 61/939,795, filed on Feb. 14, 2014.

(51) Int. Cl. G08B 21/24

(52) U.S. Cl. CPC G08B 21/24

(57) ABSTRACT

A universal reminder device for a motor vehicle having a power source. The universal reminder device includes a power sensor for connecting to the power source, whereby the power sensor is configured to automatically engage when the motor vehicle is started and to produce a warning signal when the motor vehicle is turned off. The power sensor may include an audio recording element configured to record an audio message relating to a particular reminder event by the driver.

This application claims the benefit of U.S. Provisional Patent Application Serial No. 61/939,795, filed on Feb. 14, 2014, the disclosure of which is incorporated herein by reference.

### TECHNICAL FIELD

This disclosure relates generally to a reminder and warning device and, more particularly, to a universal reminder and warning device for a driver of a motor vehicle including a visual and audio warning to alert the driver to a reminder, such as a child being secured in a child safety seat in the back seat of the motor vehicle or other various tasks or appointments.

### BACKGROUND

Child safety seats are legally required in the United States for transporting children under a certain age and certain minimum height and weight standards in automobiles and motor vehicles. In recent years, a growing epidemic is the rising number of babies and infants that have died or become seriously injured because they were left unattended in cars that become dangerously hot or cold. Generally, these tragic accidents occur inadvertently because the driver of the motor vehicle (usually a parent, guardian or other caretaker) forgets the baby or infant is strapped and locked into a child safety seat in the back seat of the motor vehicle.

Although the baby or infant may only be left unattended in the motor vehicle for a short period of time, the consequences can be tragic. Namely, the temperature in the interior of a motor vehicle parked outdoors may rise rapidly and greatly exceed, over time, the temperature outside the motor vehicle. Extreme temperatures in the interior of the motor vehicle may lead to serious injury or death of a baby or infant that is left unintentionally in the motor vehicle.

As mentioned above, these tragic accidents often occur inadvertently rather than willful neglect on the part of the parent, guardian or caretaker. Although it may be difficult to imagine forgetting one's child in an unattended vehicle, the world is extremely hectic and people often rely solely upon their daily routine. For example, one parent may seldom be responsible for transporting the child to a babysitter's house or day care facility. When that parent has to perform this task, they may simply forget about the child that is sleeping or being quiet when driving to work and forget to drop the child off before arriving at work and exiting the motor vehicle. Alternatively, they may simply be distracted during their daily commute to work.

When a person is driving a motor vehicle, they are constantly bombarded with dozens of visual and mental images, which diverts their attention. They may be late for an appointment, be under stress for a deadline at work or narrowly avoid a traffic accident when another vehicle cuts in front of them. Any of these things may cause the driver to forget about the child or other task that the driver needs to complete. While leaving a child unattended in a motor vehicle is the most extreme and potentially tragic example of being forgetful or distracted, drivers of motor vehicles often forget many other events, such as an appointment, picking up a prescription, an item being stored in the trunk of the motor vehicle or dropping off an item or documents at a specific destination.

Accordingly, there is a need for a universal warning system for the driver of a motor vehicle to provide an audio and/or visual signal to remind the driver after the vehicle is stopped and the driver is exiting the vehicle about the child being strapped in the child safety seat or some other task, event or appointment that should be completed by the driver upon exiting the vehicle.

### SUMMARY

In accordance with one aspect of this disclosure, a universal reminder device for a motor vehicle having a power source is disclosed. The universal reminder device includes a power sensor for connecting to the power source, whereby the power sensor is configured to automatically engage when the motor vehicle is started and to produce a warning signal when the motor vehicle is turned off.

The power sensor may include a sound emitter, wherein the warning signal may be an audio warning transmitted via the sound emitter. The power sensor may also include a first light source emitting a light when the power sensor is activated and a second light source. The warning signal may be a visual warning transmitted via the second light source. The warning signal may also include a visual and an audio warning In addition, the power sensor may include an audio recording element. The power sensor includes a backup battery and/or a rechargeable battery. The power sensor may also include a manual override button for turning power sensor off when the motor vehicle during operation of the motor vehicle.

In another aspect of this disclosure, a universal reminder device for a motor vehicle to remind a driver of a particular event upon shut off of the motor vehicle is disclosed. The device has a body having a first end configured for electrically connecting to the motor vehicle and a second end having a recording button and an audio recording device positioned within the body configured to record an audio message relating to the particular event by the driver. The audio message may be played upon the motor vehicle being turned off.

Another related aspect of this disclosure is a method of reminding a driver of a motor vehicle of a particular condition upon shut off of the motor vehicle. The method includes the steps of: (1) activating a power sensor electrically connected to the motor vehicle; and (2) generating an alarm from the power sensor upon shut off of the vehicle.

The method may further include the step of providing a recording button on the power sensor. The method may include the step of depressing the recording button to leave an audio message and releasing the recording button to end the recording of the audio message. The method may include continuously playing the audio message upon shut off of the motor vehicle and manually stopping the continuously playing of the audio message. The generation step may include producing an audio alarm signal and a light alarm signal. Finally, the method may include providing a backup warning signal in the event that the alarm is not generated upon shut off of the vehicle.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a side view of a universal reminder device forming one aspect of this disclosure;

FIG. 2 is an opposite side view of the universal reminder device forming one aspect of this disclosure;

FIG. 3 is a top side view of the universal reminder device forming one aspect of this disclosure;

FIG. 4 is a front view of the universal reminder device forming one aspect of this disclosure; and

FIG. 5 is a rear view of the universal reminder device forming one aspect of this disclosure.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a universal reminder and warning device is hereinafter described.

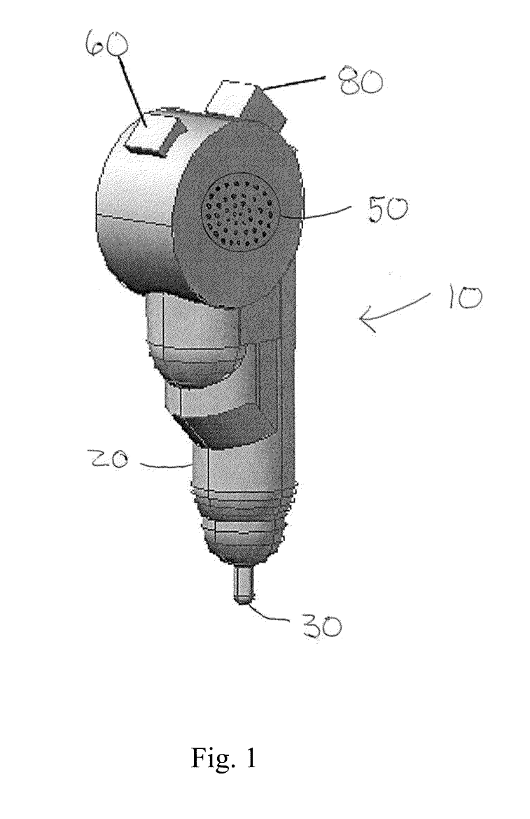

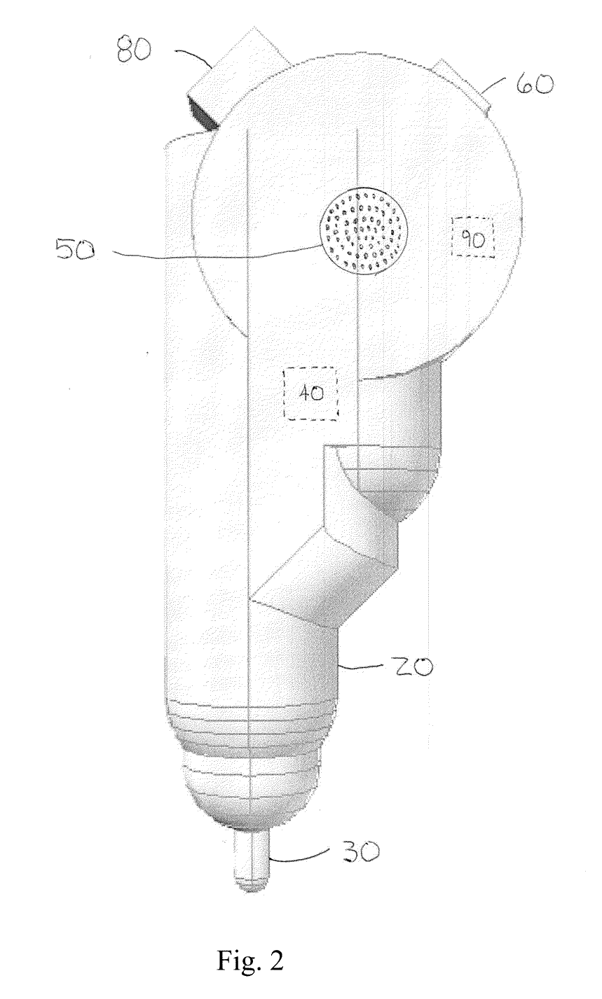

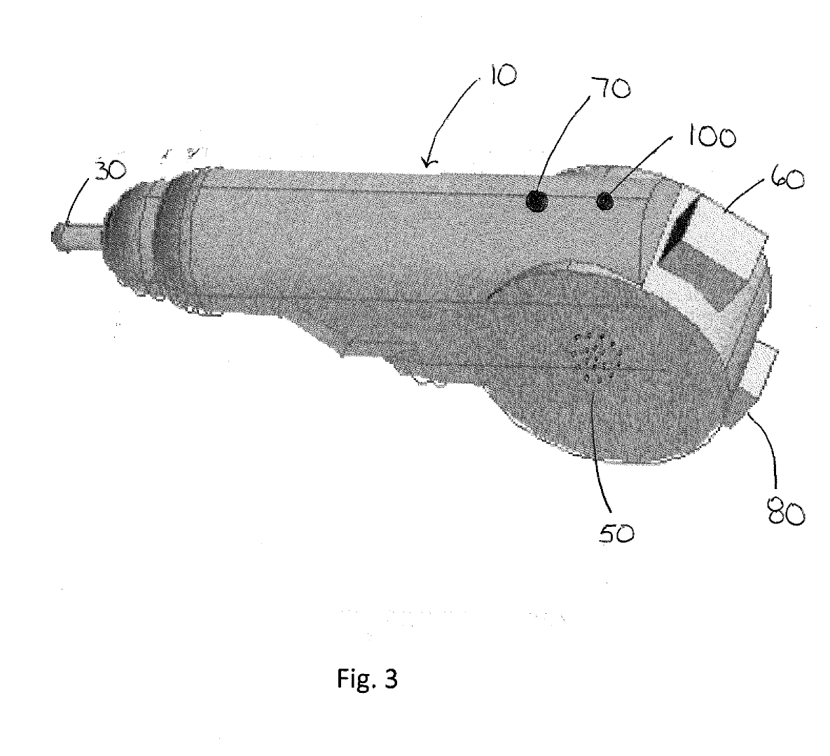

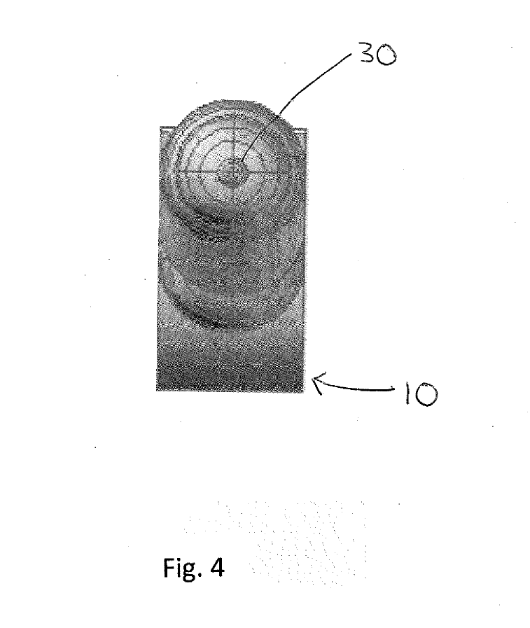

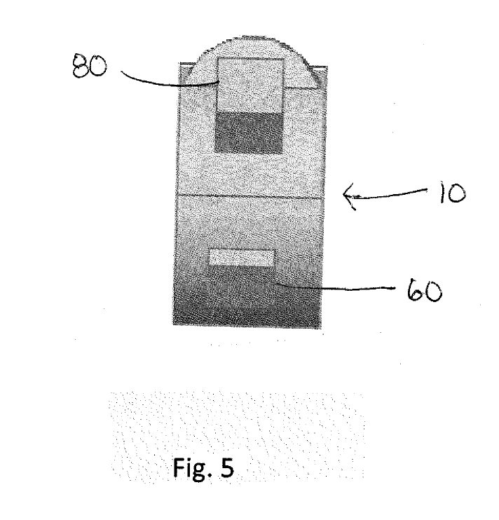

Reference is now made to FIGS. 1-5, which illustrate the universal reminder and warning device 10 that functions as a warning system for the driver of a motor vehicle. One of the primary uses of the warning system is to alert a driver when an infant or baby is strapped into a child safety seat and the child has not been removed when the driver stops and exits the vehicle. However, the system can be used to alert the driver or any passenger of any other event such as an appointment, picking up a prescription from the pharmacy, an item being stored in the trunk of the motor vehicle that needs to be removed, delivering important documents to a specific destination and the like.

The universal reminder and warning device 10 is a single, stand-alone element that is not tied to any other elements. For example, most other warning and/or safety devices are directed connected (wirelessly or otherwise) to the child safety seat in the rear of the vehicle. In contrast, the universal reminder and warning device disclosed herein may be used to alert the driver to any particular reminder condition, such as an appointment, picking up a prescription from the pharmacy, an item being stored in the trunk of the motor vehicle that needs to be removed, delivering important documents to a specific destination and the like.

The universal reminder and warning device includes a lightweight rigid body 20 or power sensor, which is configured to plug into the power charger (often called the cigarette lighter) in a motor vehicle. The body 20 is similar in appearance to a cellular or mobile phone battery charger or adapter without the cord that attaches to the actual cell phone and is typically made of a rigid material, such as hard plastic. The first end of the body 20 is substantially cylindrically-shaped including a tip, plug or power connector 30 at its tip such that it may be plugged directly into and electronically connect to the power charger of the automobile or motor vehicle.

The device 10 will automatically be turned “on” when the motor vehicle is started by the operator as long as the device is plugged into the power charger of the automobile. When a driver turns off the vehicle, a warning signal such as a sound and/or a visual light will be emitted from the device 10 to remind the driver to remember something, such as a baby or infant being fastened in a child safety seat in the rear of the vehicle or a package needs to be delivered to the post office.

The opposite end of the device 10 may be tapered such that the height at the opposite end is taller than the first end, i.e., the end having the power connector. The opposite end has a substantially circular portion for housing a backup battery 40, such as a triple A (AAA) battery. Although the device is configured to automatically be turned “on” when a vehicle is started by the operator as long as the device is plugged into the power charger of the automobile, the backup battery is designed to automatically sound an alarm when the car is shut off and the driver's door is opened to alert the driver of a particular reminder condition in the event that power or the electrical connection is lost between the power connector and the power charger of the automobile. Furthermore, a rechargeable battery may be located within the body of the device.

The body 20 of the device 10 includes a sound emitter 50 for emitting a warning sound when the vehicle is shut off to remind the driver of a particular reminder condition. The body 20 of the device may include a first light source 60 that emits light, such as a strobe light, a pulsing or flashing light or the like when the vehicle is shut off to remind the driver of a particular reminder condition. The body 20 of the device may further include a second light source 70 that may glow in a bright color, such as red when the device is on may be positioned on the device 10. This light is intended to notify the driver that the device is properly working. Of course, it should be appreciated that the second light source may produce a variety of different colors and/or color patterns.

Finally, the device 10 may include a recording button 80 located near the opposite end of the body of the device. The button 80 may be depressed and it begins recording an audio message left by the driver in an audio recording element 90 located within the device. The audio recording element may be programmed to record an audio message lasting at least twenty (20) seconds. For example, the driver may have a short grocery list or a task that must be completed during his/her drive. The driver may depress the button 80 and leave an audio message for himself. Once the driver releases the button, the audio recording element quits recording the audio message. When the ignition of the vehicle is shut off, the recording would automatically play back continually until deleted by the person that made the recording. As a result, when the driver reaches his location and shuts off the vehicle, the driver hears the audio message and will not forget the particular task that he intended to complete.

Every time the automobile or motor vehicle is started, the driver may hear a sound, such as a “beep,” which informs the driver that the device 10 has been activated and is properly functioning. The driver can then look at the device 10 at any time and see the glowing red light to ensure that the device remains activated. If a driver does not need to be reminded of any event, he/she can physically turn “off” the device 10 when the vehicle is started using a manual power override on/off switch or button 100 that may be positioned on the body so that the driver can turn off the device without removing the power charger from the power connector of the automobile.

This may be particularly advantageous if the driver does not need a particular reminder on a trip, yet does not want to remove the power charger from the power connector. The driver may turn off the universal reminder device, yet it will automatically turn on the next time the automobile is started because it was not removed from the power connector. In other words, whenever the vehicle is turned off and restarted, the device 10 will automatically be turned on again every time so that the driver does not have to manual turn the device back on each time the automobile is started.

Whenever the device 10 is activated, it will emit a warning signal when the ignition of the automobile is turned to the off thereby reminding the driver that they need to remember something important, such as a baby or infant being fastened in a child safety seat in the rear of the automobile. For example, the warning signal may be a loud sound emitted from the device. Alternatively, a strobe light may be emitted from the device. In addition, the warning signal may be a combination of both a sound and light signal.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1. A universal reminder device for a motor vehicle having a power source, comprising:
a power sensor for connecting to the power source,
whereby the power sensor is configured to automatically engage when the motor vehicle is started and to produce a warning signal when the motor vehicle is turned off.

2. The device according to claim 1, wherein the power sensor includes a sound emitter.

3. The device according to claim 2, wherein the warning signal is an audio warning transmitted via the sound emitter.

4. The device according to claim 1, wherein the power sensor includes a first light source emitting a light when the power sensor is activated.

5. The device according to claim 4, wherein the power sensor includes a second light source.

6. The device according to claim 5, wherein the warning signal is a visual warning transmitted via the second light source.

7. The device according to claim 1, wherein the warning signal includes a visual and an audio warning.

8. The device according to claim 1, wherein the power sensor includes an audio recording element.

9. The device according to claim 1, wherein the power sensor includes a backup battery.

10. The reminder device according to claim 1, wherein the power sensor includes a rechargeable battery.

11. The reminder device according to claim 1, wherein the power sensor includes a manual override button for turning power sensor off when the motor vehicle during operation of the motor vehicle.

12. A universal reminder device for a motor vehicle to remind a driver of a particular event upon shut off of the motor vehicle, comprising:
a body having a first end configured for electrically connecting to the motor vehicle and a second end having a recording button;
an audio recording device positioned within the body configured to record an audio message relating to the particular event by the driver,
whereby the audio message is played upon the motor vehicle being turned off.

13. A method of reminding a driver of a motor vehicle of a particular condition upon shut off of the motor vehicle, comprising:
activating a power sensor electrically connected to the motor vehicle; and
generating an alarm from the power sensor upon shut off of the vehicle.

14. The method according to claim 13, further comprising providing a recording button on the power sensor.

15. The method according to claim 14, further comprising depressing the recording button to leave an audio message.

16. The method according to claim 15, further comprising releasing the recording button to end the recording of the audio message.

17. The method according to claim 16, further comprising continuously playing the audio message upon shut off of the motor vehicle.

18. The method according to claim 17, further comprising manually stopping the continuously playing of the audio message.

19. The method according to claim 13, wherein the generation step includes producing an audio alarm signal and a light alarm signal.

20. The method according to claim 13, further comprising providing a backup warning signal in the event that the alarm is not generated upon shut off of the vehicle.
